(19) United States
(12) Patent Application Publication
(10) Pub. No.: US 2018/0147703 A1
(43) Pub. Date: May 31, 2018

(54) SCREWDRIVER WITH ROTATING LEVER

(71) Applicant: Yi-Feng LIU, New Taipei (TW)

(72) Inventor: Yi-Feng LIU, New Taipei (TW)

(21) Appl. No.: 15/364,814

(22) Filed: Nov. 30, 2016

(51) Int. Cl. B25B 23/00; B25B 15/02; B25B 21/00; B25G 1/10

(52) U.S. Cl. CPC B25B 23/0042; B25G 1/105; B25B 21/00; B25B 15/02

(57) ABSTRACT

A screwdriver with rotating lever according to this invention includes a screwdriver head. The screwdriver head includes a rod, an operation portion formed at a first end of the rod, and a fixing portion formed at a second end of the rod. The rod is a polygonal prism and extends spirally from the operation portion to the fixing portion to form a spiral curved surface. With the rod formed with the spiral curved surface, when the screwdriver with rotating lever operates, the rod is of higher strength and may bear stronger torsion stress for increasing the service life of the screwdriver.

### FIELD OF THE INVENTION

This invention relates to a screwdriver and particularly to a screwdriver with rotating lever.

### BACKGROUND OF THE INVENTION

Currently, screws are applied very widely, for example, to various electronic devices, electrical apparatus, furniture and the like. However, a screw must be used together with a screwdriver. Thus, to make the screwdriver be a laborsaving and user-friendly tool for users, each hand tool developer improves the screwdriver.

For example, in Taiwan Patent No. M525245, titled a soft handle screwdriver, the screwdriver comprises a screw rod and a composite handle. One end of the screw rod is a driving portion, while the other end is a connection portion. The composite handle is securely connected to the connection portion of the screw rod. Further, the composite handle includes a handle framework and a plurality of soft rubber-coating parts wrapping the outer side of the handle framework. The handle framework is securely connected to the connection portion of the screw rod through injection process. The soft rubber-coating parts are separately arranged at intervals and made to wrap the handle framework. Hard portions are formed in the soft rubber-coating parts and in the handle framework adjacent between the soft rubber-coating parts. Each of the soft rubber-coating parts and each of the hard portions are adjacently staggered. With the soft rubber-coating parts and the hard portions that are arrayed therebetween and combined with each other, users may hold the screwdriver more firmly and accurately, which may thereby protect users from injury by reducing the excessive friction caused between the composite handle and users' hands.

In the prior art mentioned above, the screw rod is in the form of a bar. When the soft handle screwdriver is used with excessive torsion stress, its screw rod is subject to bend or break.

Consequently, because of the technical defects described above, to provide the rotary valve improver, the applicant, based on many years of research and experience in the relevant industry, has developed the present invention, which may effectively improve the defects described above.

### SUMMARY OF THE INVENTION

This invention is mainly to solve the defect of a conventional screwdriver of which a screw rod cannot bear a higher torsion stress.

To achieve the above object, this invention provides a screwdriver with rotating lever, comprising a screwdriver head. The screwdriver head comprises a rod, an operation portion formed at a first end of the rod, and a fixing portion formed at a second end of the rod. The rod that is a polygonal prism extends spirally from the operation portion to the fixing portion to form a spiral curved surface.

It is apparent from the above description that, being compared with the prior art, this invention is featured in that, with the rod formed with the spiral curved surface, when the screwdriver with rotating lever operates, the rod is of higher strength and may bear stronger torsion stress for increasing the service life of the screwdriver.

The foregoing objectives and summary provide only a brief introduction to the present invention. Other objects, features, and advantages of the present invention will become conspicuous to those skilled in the art upon reading the following detailed descriptions accompanying by the illustrations.

### BRIEF DESCRIPTION OF THE DRAWINGS

FIG. 1 is a schematic view illustrating a screwdriver in a first embodiment of this invention.

FIG. 2 is a schematic view illustrating the screwdriver in a second embodiment of this invention.

FIG. 3 is a schematic view illustrating the screwdriver in a third embodiment of this invention.

FIG. 4 is a schematic view illustrating the screwdriver in a fourth embodiment of this invention.

FIG. 5 is a schematic view illustrating the screwdriver in a fifth embodiment of this invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

In order to further know the features and technical means of this invention, refer to the detailed description according to this invention accompanied with drawings; however, the accompanied drawings are provided for reference and illustration only and are not limited to this invention.

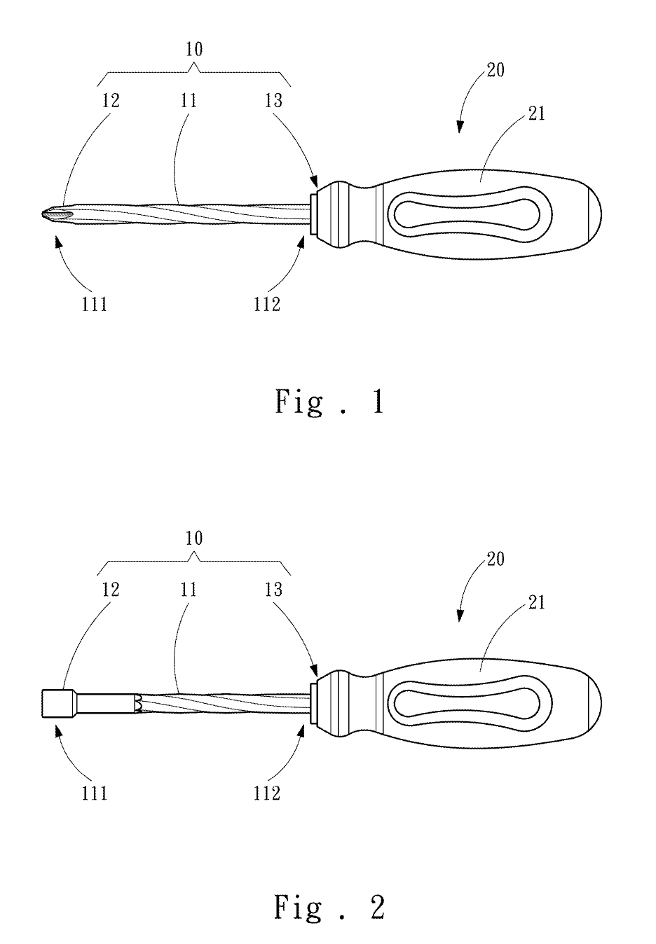

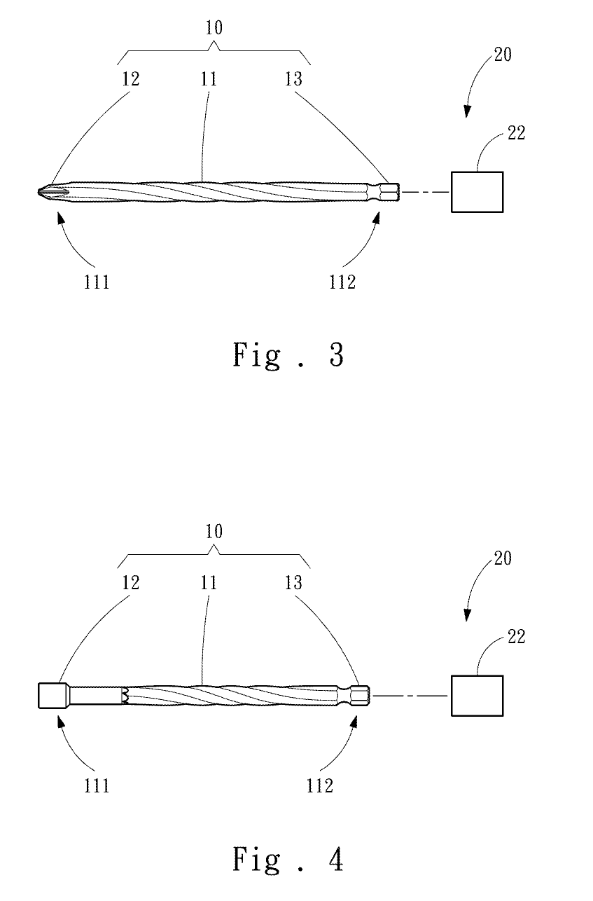

Refer to FIG. 1 through FIG. 5 respectively illustrating a screwdriver in first, second, third, fourth, and fifth embodiments of this invention. A screwdriver with rotating lever according to this invention comprises a screwdriver head 10. The screwdriver head 10 comprises a rod 11, an operation portion 12, and a fixing portion 13. The operation portion 12 is formed at a first end 111 of the rod 11. In an embodiment, the operation portion 12 may be a screwdriver or a wrench. The screwdriver is, for example, a flat blade screwdriver or a phillips screwdriver, as shown in FIGS. 1 and 3. The wrench is, for example, an allen wrench or an airwrench, as shown in FIGS. 2 and 4. The above-mentioned operation portion 12 is merely taken for example and is not limited to this invention. The fixing portion 13 is formed at a second end 112 of the rod 11. The rod 11 is a polygonal prism and extends spirally from the operation portion 12 to the fixing portion 13 to form a spiral curved surface. The radial cross-section of the polygonal prism is a polygon and the spiral curved surface is formed with a plurality of spiral axis lines corresponding to the polygons. The spiral axis lines stay non-horizontal. In this embodiment, the polygon is selected from the group consisting of a regularly triangle, a regularly quadrangle, a regularly pentagon, a regularly hexagon, or and a regularly octagon.

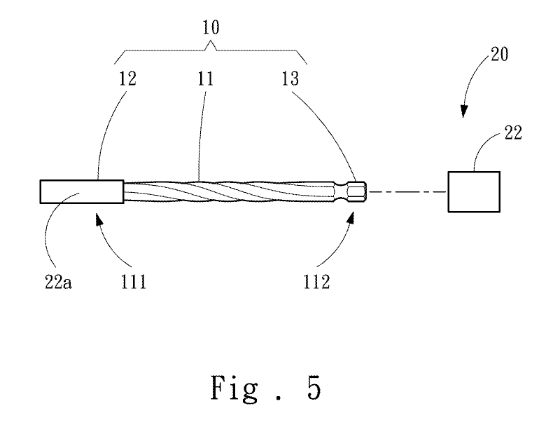

In this invention, the screwdriver with rotating lever further comprises a rotating unit 20. The rotating unit 20 is correspondingly fixed to the fixing portion 13. In this embodiment, the rotating unit 20 may be a handle 21 or a holder 22. The handle 21 is larger than the screwdriver head 10 in diameter to increase the rotation torque of screwdriver head 10 for smooth rotation at the time of operation, as shown in FIGS. 1 and 2. One end of the holder 22 is correspondingly fixed to the fixing portion 13, while the other end of the holder 22 is fixed to an electric drive unit (not shown). The rotation speed of the electric drive unit is controlled to drive the screwdriver head 10 to rotate, as shown in FIGS. 3 and 4. In an embodiment, the operation portion 12 may be also the holder 22a. One end of the holder 22a is fixed to the rod 11, while the other end of the holder 22a may work with a random tool corresponding to the holder 22a, as shown in FIG. 5. In this invention, the handle 21 and the holder 22 are merely taken for example, which works as long as they can be fixed to the fixing portion 13 and drive the screwdriver head 10 and is not limited to the examples mentioned above.

To sum up, compared with the conventional screw rod that is in the form of a bar in the prior art, this invention is featured the rod formed with the spiral curved surface. Being compared with the prior art, this invention provides the rod that is of higher strength and may bear stronger torsion stress, when the screwdriver with rotating lever operates, for increasing the service life of the screwdriver.

What is claimed is:

1. A screwdriver with rotating lever, comprising:
a screwdriver head, comprising a rod, an operation portion formed at a first end of the rod, and a fixing portion formed at a second end of the rod, wherein the rod is a polygonal prism and extends spirally from the operation portion to the fixing portion to form a spiral curved surface.

2. The screwdriver with rotating lever according to claim 1, wherein the screwdriver further comprises a rotating unit and the rotating unit is correspondingly fixed to the fixing portion.

3. The screwdriver with rotating lever according to claim 2, wherein the rotating unit is a handle or a holder.

4. The screwdriver with rotating lever according to claim 1, wherein the radial cross-section of the polygonal prism is a polygon, the polygon is selected from the group consisting of a regular triangle, a regular quadrangle, a regular pentagon, a regular hexagon, and a regular octagon.
